(19) United States
(12) Patent Application Publication
(10) Pub. No.: US 2025/0237822 A1
(43) Pub. Date: Jul. 24, 2025

(54) Detachable Connector for Co-Packaged Optics

(71) Applicant: Teramount Ltd., Jerusalem (IL)

(72) Inventors: Hesham Taha, Jerusalem (IL); Abraham Israel, Jerusalem (IL)

(21) Appl. No.: 19/175,630

(22) Filed: Apr. 10, 2025

Related U.S. Application Data
(62) Division of application No. 17/512,200, filed on Oct. 27, 2021.

(51) Int. Cl. G02B 6/42

(52) U.S. Cl. CPC G02B 6/4214; G02B 6/423; G02B 6/4239; G02B 6/4243

(57) ABSTRACT

Apparatus and method for detachably connecting at least one optical fiber of a detachable photonic plug to a photonic integrated circuit (PIC). The apparatus may include a receptacle configured to receive a detachable photonic plug configured to couple at least one optical fiber to a photonic integrated circuit (PIC); and a photonic bump of the PIC, the photonic bump may include a least one fine alignment feature. The method may include mounting a receptacle over at least a portion of the PIC; after completion of the mounting, inserting the detachable photonic plug into the receptacle; and after the detachable photonic plug is inserted in the receptacle, securing the detachable photonic plug in the receptacle.

### CROSS-REFERENCE TO RELATED APPLICATIONS

This application is a divisional of U.S. application Ser. No. 17/512,200, filed Oct. 27, 2021, the content of which is incorporated by reference in its entirety.

### TECHNICAL FIELD

The present disclosure relates generally to coupling an optical fiber connector to a substrate, and more particularly to a detachable connector for co-packaged optics to couple optical fibers to an optoelectronic integrated circuit (IC).

### BACKGROUND

Communications systems and datacenters are required to handle massive data at ever increasing speeds and ever decreasing costs. This often requires a large amount of space and entails high power consumption. To meet these demands, optical fibers and optical integrated circuits (ICs) such as, for example, a photonic integrated circuit (PIC) or integrated optical circuit, are used together with high speed electronic ICs. A PIC is a device that integrates multiple photonic functions in a manner that is similar to the way an electronic IC or radio frequency (RF) IC integrates different electronic or RF functions onto a single chip. PICs are typically fabricated using indium phosphide or silicon oxide (SiO₂), which allows for the integration of various optically active and passive functions on the same chip.

The coupling of PICs to optical fibers is not as well advanced as the integration and/or coupling of off-chip electronics to ICs. Specifically, the challenges facing the making of optical connections to a PIC are much more complex than merely connecting wire connections to electronic ICs which may be mounted on a printed circuit board (PCB). Some difficulties of connecting optical fibers to a PIC are inherent in the characteristics of optical packaging such as the assembly tolerance between PIC and the fiber connector.

Existing solutions utilize various techniques for connecting optical fibers to PICS. One technique uses various types of butt connections to connect fiber to the edge of a PIC. This may be achieved by connecting the butt of a fiber to a planar waveguide at the edge of PIC. This technique is efficient only if the cross sectional area of the propagating mode of the fiber and the waveguide area of the fiber core and the waveguide are of similar size. In most cases, this technique suffers from poor assembly tolerance.

Another technique suggests laying a section of fiber on top of the surface of PIC where the end of the fiber has been cut at an angle to form an angled tip. The angled tip has a flat surface which reflects a light beam down into a waveguide grating coupler disposed on the integrated circuit. The light beam is reflected off the reflective surface of the angled tip by total internal reflection. The waveguide grating coupler is designed to accept the slightly diverging light beam from the reflective surface of the angled tip of the fiber. The light beam can also propagate through the fiber to a chip coupler in the opposite direction, up from the substrate through the waveguide grating and into an optical fiber after bouncing off the reflective surface of the angled tip.

Disadvantageously, all of the above-noted techniques require precise alignment and active positioning of optical fiber with respect to PIC. As such, current techniques suffer from having very tight alignment tolerances as a requirement to gain an efficient connectivity between PIC and the fiber. For example, a misalignment between an optical fiber and a PIC of 1-2 microns (μm) would result in a signal loss of about 3 db. Furthermore, the alignment must be performed with expensive equipment or labor intensive assembly solutions. As a result, a mass production of PICs and/or optical couplers is not feasible.

Direct attach connection of fibers to PIC while useful for small numbers of fibers, e.g., ten or less, are generally unsuitable for use for connections tens or hundreds of fibers that would make up a fiber connector.

Another disadvantage of such prior art techniques for direct attach connection of fibers to PIC is that they are permanent connections, i.e., the fibers are effectively not removable after being attached. For example, a V-groove approach requires direct bonding of fiber on a system-in-package (SiP) chip. Such an arrangement also requires passing the fibers through at least one reflow process. Given that the connections are made prior to the reflow process, which is typically performed at 240° C. to 260° C., it is possible that the reflow process could harm the glass of the fibers.

A further disadvantage of such permanent attachments is that the successful yield of the connections is often low, which is problematic.

Yet an additional disadvantage of such connections is the fact that they are permanent, i.e., they are not detachable. However, the ability to remove such connections can be useful for maintenance and long term care.

Lastly, while detachable connections exist for use with multi-mode fibers as these multi-mode fibers have large tolerances, it is often desired to use single mode fiber for the various connections and single mode fibers have very small tolerances which further complicate, and make it a challenge, to provide a detachable connection.

It would therefore be advantageous to provide a fiber-to-chip optical coupling solution that would overcome the deficiencies of the existing solutions.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments disclosed herein include a detachable photonic plug for coupling an optical fiber to a photonic integrated circuit (PIC), comprising: a detachable plug die; an optically transparent spacer coupled to the detachable plug die; and at least one optical fiber held between the detachable plug die and the spacer.

Certain embodiments disclosed herein include a receptacle adapted to receive a detachable photonic plug adapted to couple at least one optical fiber to a photonic integrated circuit (PIC); and a photonic bump of the PIC, the photonic bump having a least one fine alignment feature.

Certain embodiments disclosed herein include a method for detachably connecting at least one optical fiber of a detachable photonic plug to a photonic integrated circuit (PIC). The method comprises: permanently mounting a receptacle so that at least a portion of the receptacle extends over at least a portion of the PIC; after completion of mounting, inserting the detachable photonic plug into the receptacle; and after the detachable photonic plug is inserted in the receptacle, securing the detachable photonic plug in the receptacle.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an illustrative embodiment 100 of a fully assembled detachable connector for co-packaged optics that is coupled to a multi-chip module via a PIC;

FIG. 2 shows an expanded view of the illustrative embodiment shown in FIG. 1;

FIG. 3 shows another view of the embodiment of FIG. 1 where a detachable plug die is inserted into a receptacle;

FIG. 4 shows an exploded view of the view of FIG. 3 but without the optical fibers that are shown in FIG. 3;

FIG. 5 shows that the individual fibers of a fiber ribbon inserted into trenches of a photonic plug die shown in FIGS. 2 and 4;

FIG. 6 shows a cross sectional view of an embodiment of a detachable connector when assembled and its optical path;

FIG. 7 shows an illustrative surface of a detachable plug in which first curved mirrors and tilted flat mirrors are formed along with trenches for guiding optical fibers;

FIG. 8 is an exemplary diagram utilized to describe the angles and distance of an embodiment; and

FIG. 9 shows a flowchart of an illustrative process for assembling a detachable plug and connecting an end of fibers to a PIC in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Based on the problems stated above, a scalable single-mode fiber to chip assembling methodology is needed in applications where fiber high density or large port count is used, for example, co-packaged optical switch connectivity. Co-packaged optical connectivity brings multiple fibers closer to switch die or other types of die which may be packaged on an expensive packaging platform such as a Multi-Chip Module (MCM). Therefore, co-packaged optical connectivity should be compatible with standard chip packaging methodologies and equipment. In the disclosed embodiments, the fiber is separated from the MCM packaging steps, and the fiber and MCM packaging is kept to the last stage in a detachable way is not only unique, but also makes the process a scalable technology. In addition, advantageously, detachable connectors as disclosed herein makes it possible to assemble fibers after the high temperature reflow soldering process is completed. Further advantageously, the disclosed embodiments are suitable for use with single mode fibers.

Unless otherwise explicitly specified herein, the drawings are not drawn to scale. Also, identically numbered components within different ones of the FIGS. refer to components that are substantially the same.

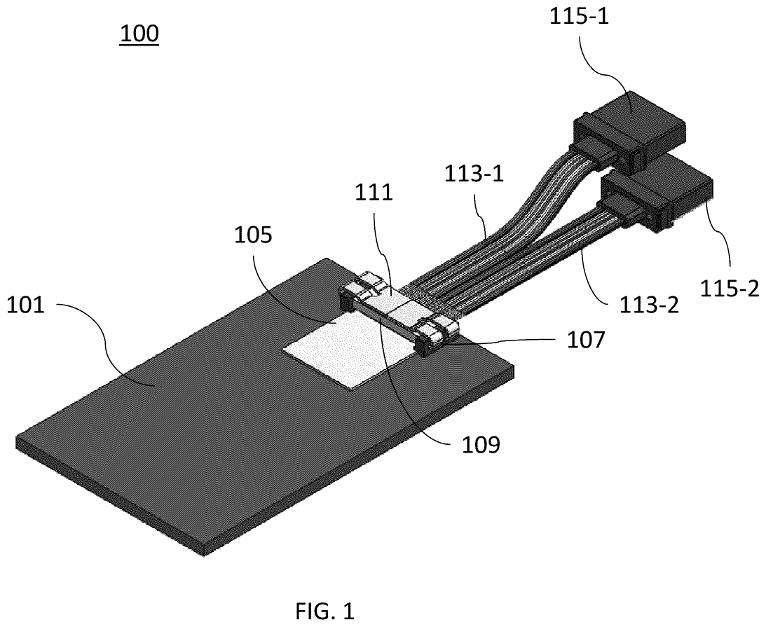

FIG. 1 shows an illustrative embodiment 100 of a fully assembled detachable connector for co-packaged optics that is coupled to a multi-chip module via a PIC. Shown in FIG. 1 are a) MCM 101, b) PIC 105, c) receptacle 107, d) detachable plug die 109, e) removable clip 111, f) optical fibers 113 arranged into fiber ribbons 113-1 and 113-2, and g) fiber ribbon connector couplers 115-1 and 115-2.

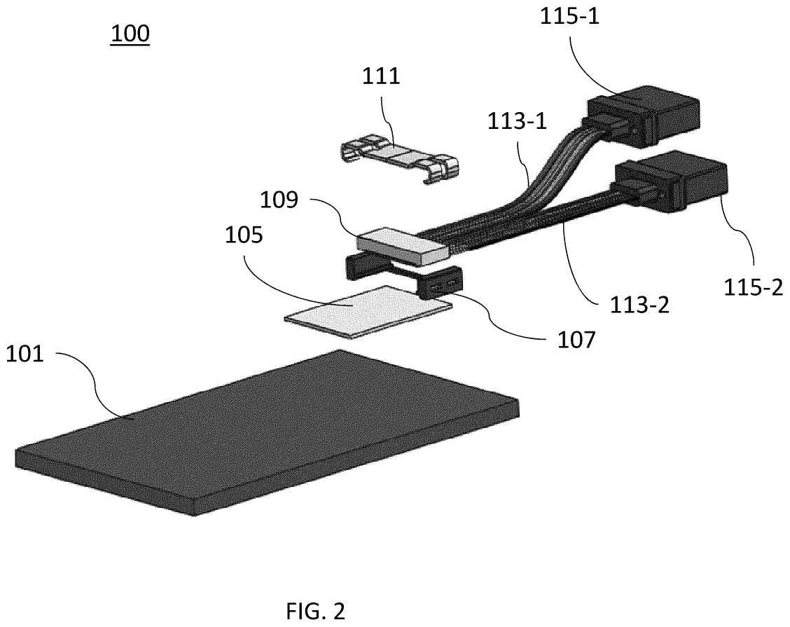

FIG. 2 shows an expanded view of the illustrative embodiment 100 that is shown in FIG. 1.

MCM 101 provides for various electrical functions. Typically MCM 101 provides the base for multiple chips mounted thereon that perform various electrical and optical functions. For example, one or more photonic integrated circuits (PICs) 105, may be mounted on MCM 101 although in FIGS. 1 and 2 only a single PIC is shown as a non-limiting example. One or more electronic circuits, e.g., switches and application specific integrated circuits (ASICs), may also be mounted on MCM 101. MCM 101 may itself be mounted on a board (not shown in FIG. 1 or 2). PIC 105 is reflow soldered to MCM 101.

Receptacle 107 is reflow soldered or glued, e.g., using an adhesive, to PIC 105, MCM 101 or a combination thereof. This may be performed, advantageously, using a standard pick and place machine and as such, advantageously, it can be placed with high accuracy. It may be placed during the packaging process, e.g., during the placing of one or more chips, e.g., an ASIC on the MCM.

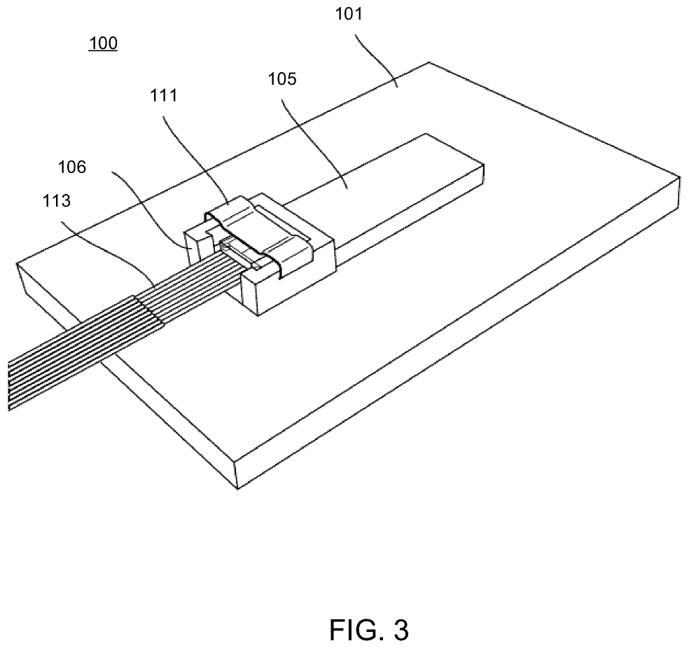

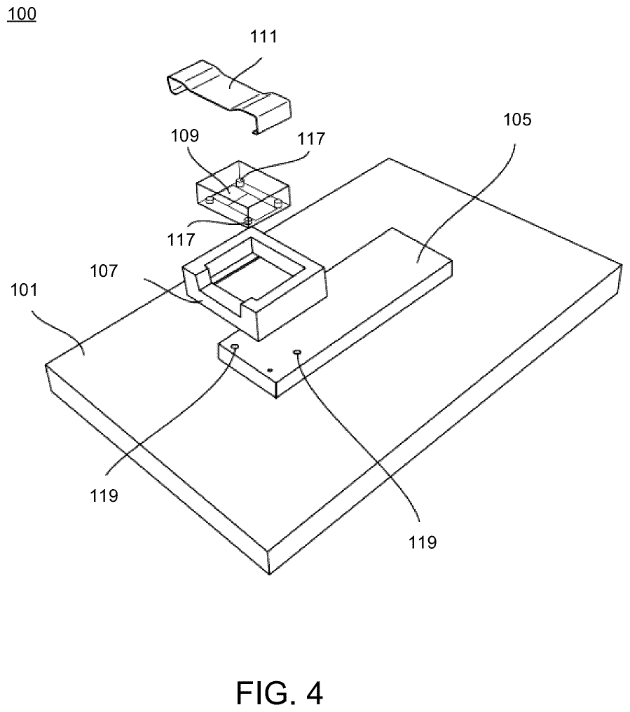

FIG. 3 shows another view of embodiment 100 where detachable plug die 109 is inserted into receptacle 107. FIG. 4 shows an exploded view of the view of FIG. 3 but without optical fibers 113.

Detachable plug die 109 is described further hereinbelow. Detachable plug die 109 is detachable due to its ability to be inserted into and correspondingly removed from receptacle 107.

Removable clip 111 extends over the top of receptacle 107 and may press down on detachable plug die 109 in order to keep the components in place. In one embodiment, removable clip 111 extends over the top and around two opposing sides of receptacle 107 which it grips to stay in position. Receptacle 107 may have one or more indentations (not shown) to aid clip 111 to remain in place. In one embodiment, clip 111 remains in place due to friction. In one embodiment, clip 111 may be attached to PIC 105 or MCM 101. After being placed, removable clip may be removed to allow detachable plug die 109 and fibers 113 to be separated from PIC 105. Although shown in the embodiments herein as being fully detachable, those of ordinary skill in the art will readily recognize that at least one end of clip 111 may be arranged to be permanently attached to receptacle 107, e.g., using a hinge mechanism.

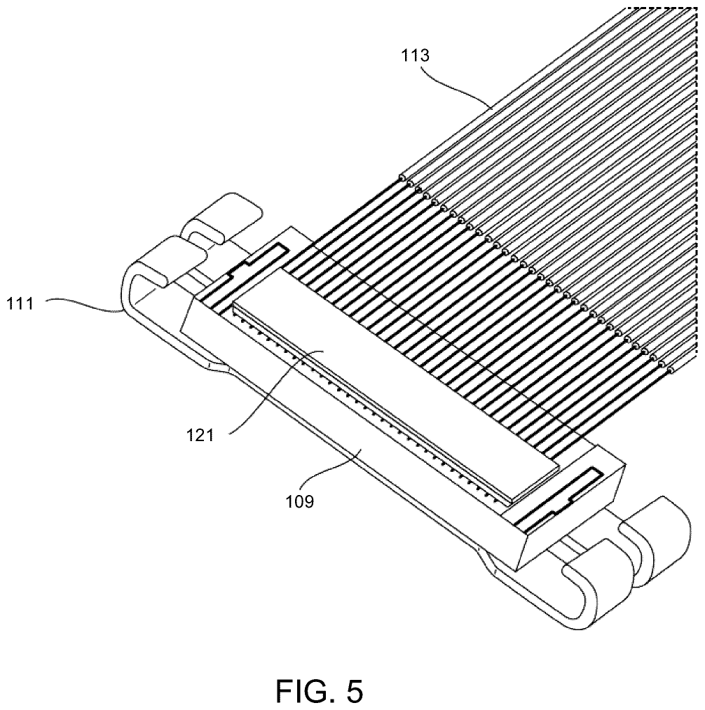

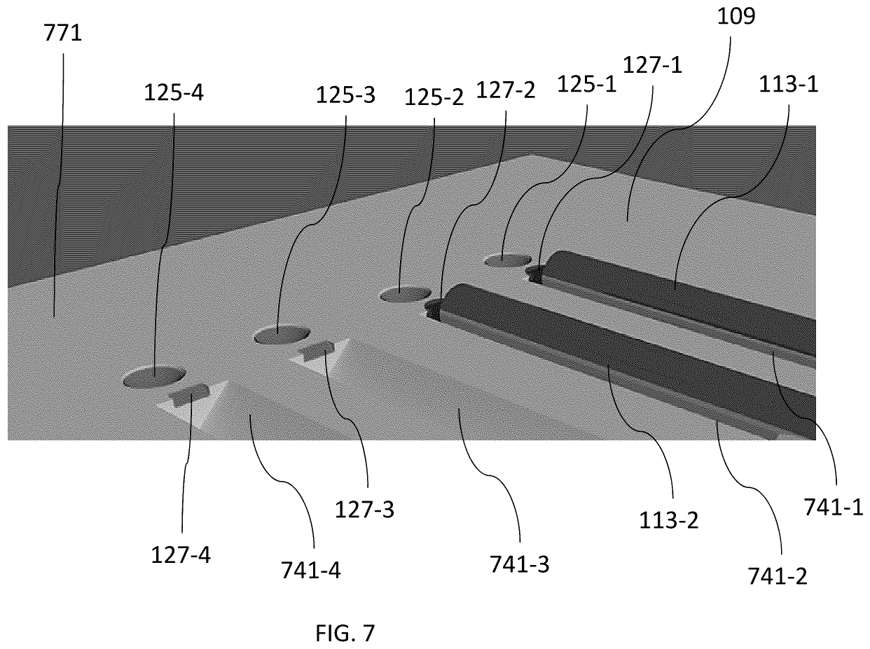

FIG. 5 shows that the individual fibers 113 of fiber ribbon 113 are inserted into trenches, e.g., V-grooves, shown in more detail in FIG. 7, formed in detachable plug die 109 to keep them aligned and the trenches are typically in parallel and typically each trench extends part-way across detachable plug die 109 as described further hereinbelow in connection with FIG. 7. The trenches hold the fibers and keeps them aligned, which may be in cooperation with spacer 121 and an adhesive.

Detachable plug die 109, spacer 121, and fiber 113 taken together may be considered to be a detachable photonic plug that can be used to connect optical signals between PIC 105 and the fibers to which fiber ribbon connector couplers 115 are connected. The components of the detachable photonic plug, including detachable plug die 109, fibers 113, and spacer 121 are assembled, e.g., as shown in FIG. 5, prior to being inserted into receptacle 107.

Spacer 121 is used at least in part to control the distance between detachable plug die 109 and PIC 105 so as to enable the proper optical design of the system. Spacer 121 may also be used to at least partially encapsulate and help hold in place fibers 113. To this end, in some embodiments an adhesive may be employed between at least a portion of glass spacer 121 and at least a portion of plug die 109 to keep spacer 121 attached to plug die 109. In some embodiments, adhesive may also be placed within the trenches or around optical fibers 113.

The adhesive should have an appropriate index of refraction so as to minimize optical losses. For example, when optical fibers 113 and spacer 121 is made from fused silica that has an index of refraction around 1.4, in order to minimize optical losses, the index of refraction of the adhesive should be around 1.4 as well. Those of ordinary skill in the art will readily be able to select an adhesive having an appropriate index of refraction based on the materials employed in their various applications. Spacer 121 is optically transparent to at least one wavelength of light being carried by optical fibers 113 and employed by PIC 105. Spacer 121 may be made of any transparent and non-conductive material, such as glass, polydimethylsiloxane, or any other encapsulation material with appropriate refractive index.

Initial insertion of the detachable photonic plug, by initial insertion of detachable plug die 109 thereof, into receptacle 107 provides a rough positioning tolerance of +/−100 m as a first step before fine alignment. In other words, receptacle 107 will position detachable plug die 109 between −100 m to +100 m on both the x and y axis, where 0 m is the ideal position. When detachable plug die 109 is fully pressed into receptacle 107, fine alignment male features 117, e.g., small male protrusions, of detachable plug die 109, e.g., as seen in FIG. 4, connect to corresponding fine alignment female features 119 of PIC 105, e.g., small recesses, e.g., as seen in FIG. 4, that match the size and shape of fine alignment male features 117, so as to provide +/−5 m or better fine positioning tolerance for the location of detachable plug die 109. Each of fine alignment male features 117 and fine alignment female features 119 may be produced by wafer level manufacturing processes on both PIC 105 and the detachable plug die 109. Advantageously, such a mechanical structure where the alignment is performed using such alignment features produced at the wafer level provides for superior control of the alignment.

In one embodiment, fine alignment features may be incorporated into spacer 121 in addition to or in lieu of those of detachable plug die 109. In one embodiment, detachable plug die 109 may include alignment features to help insure proper placement of spacer 121.

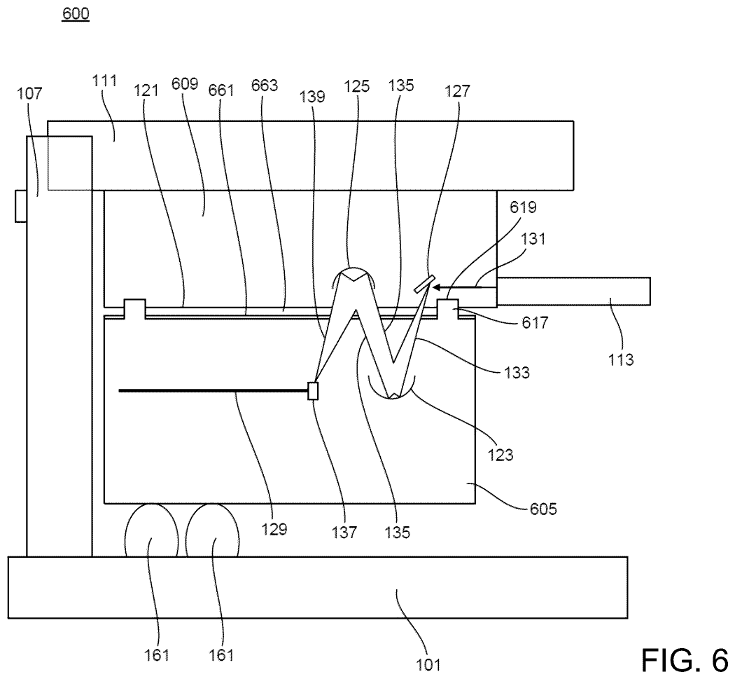

FIG. 6 shows a cross sectional view of an embodiment 600 of a detachable connector when assembled and the optical path. However, a difference between the embodiment of FIG. 6 and that of FIG. 4 is that in FIG. 6 detachable plug die 609 has female fine alignment features 619 instead of male fine alignment features 119 while PIC 605 has male fine alignment features 617 instead of male fine alignment feature 117. However, from the point of view of light traversing from fiber 113 to PIC 605 via detachable plug die 609, the same path is undertaken when using PIC 105 and detachable plug die 109.

The optical path includes in part a plurality of mirrors, and in particular, first curved mirror 123, second curved mirror 125 and tilted flat mirror 127. Tilted flat mirror 127 is utilized to direct a light beam from optical fiber 113 to first curved mirror 123 and vice-versa. This optical fiber 113 is held in an orientation with respect to PIC 605 so as to ensure that light from PIC 605 goes into optical fiber 113 and vice-versa. Tilted flat mirror 127 may be formed by being etched using a CMOS etching process or in an imprint process. The particular angle employed is based on the optical path between optical fiber 113 and first curved mirror 123 and is selected so that light from tilted flat mirror 127 is reflected to substantially the center of first curved mirror 123.

First and second curved mirrors 123 and 125 are placed so that their respective reflective curved surfaces face in opposite directions to each other. Specifically, first curved mirror 123 is within PIC 605 with its curved reflective surface facing generally toward detachable plug die 609 while second curved mirror 125 is within detachable plug die 609 with its curved reflective surface facing generally toward PIC 605. As a result of the arrangement of the mirrors, light from fiber 113 ultimately is directed into waveguide of PIC 105 and vice-versa, depending on the application. Advantageously, the arrangement of the optical components allows for separation of optical fiber 113 from PIC 605 which facilitates detachability while still providing high and relaxed alignment tolerances in three-dimensions for the coupling of fibers 113 using the detachable photonic plug. In addition, further advantageously, of the optical components enables placement of the detachable plug as a one unit relative to the PIC.

In an embodiment, first and second first curved mirrors 123 and 125 are created using a process such as, but not limited to, grayscale lithography or wafer level optics imprint techniques. In an embodiment, tilted flat mirror 127, second curved mirror 125, and the fiber trenches are formed using the same wafer level manufacturing process with high alignment accuracy.

Further, each of first and second first curved mirrors 123 and 125 are created during fabrication of PIC 605 and detachable plug die 609, respectively, which ensures high accuracy positioning and accurate reflective mirrors. As a non-limiting example, the fabrication process utilized to create first curved mirrors 123 and 125 and tilted flat mirror 127 may include a Silicon-On-Insulator (SOI), complementary metal-oxide semiconductor (CMOS), wafer level optics based imprint processes, and the like.

The disclosed arrangement of the optical coupler achieves high signal efficiency with a relaxed alignment between PIC 605 and the detachable photonic plug as a unit due to the specific locations, shape, and orientation of first and second first curved mirrors 123 and 125. The respective so as to allow a light beam to be reflected from first curved mirror 123 to second curved mirror 125 and vice-versa. Specifically, first and second first curved mirrors 123 and 125 are shaped in such a way that any light beam from a source, which may be one of fibers 113, is reflected and collimated at a certain angle at a center of first curved mirror 123 and focused to a drain, e.g., waveguide 129 of PIC 605, after second curved mirror 125. Likewise, first and second first curved mirrors 123 and 125 are also shaped in such a way that any light beam from a source, e.g., waveguide 129 of PIC 605, is reflected and collimated at a certain angle at a center of second curved mirror 125 and focused to a drain, e.g., which may be one of fibers 113, after being reflected by first curved mirror 123 via tilted flat mirror 127.

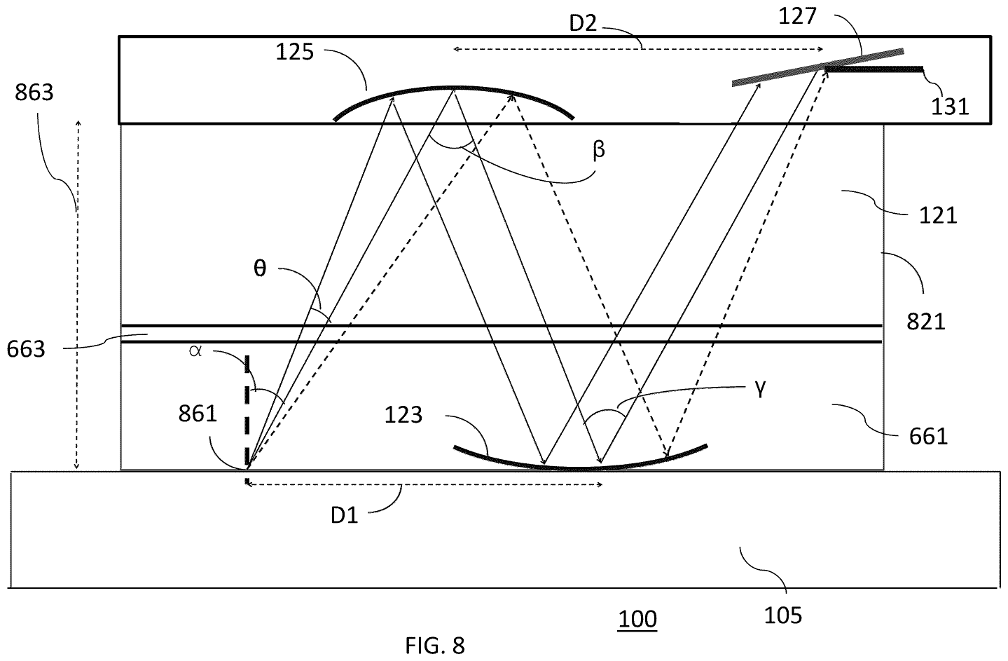

Further details of the arrangement of first and second first curved mirrors 123 and 125 are described below with respect to FIG. 8.

More specifically, as shown in FIG. 6, a light beam 131 that was received from optical fiber 113 is reflected by tilted flat mirror 127 as diverging light beam 133 toward first curved mirror 123. Light beam 133 is reflected by first curved mirror 123 as light beam 135 and reach second curved mirror 125. Second curved mirror 125 in turn reflects light beam 135 as focused light beam 139 to back vertical to horizontal propagation converter 137. Vertical to horizontal propagation converter 137 converts received focused light beam 137, which has primarily vertical propagation to a horizontal propagation for light insertion into waveguide 129 of PIC 605. The optical path is the same but in reverse for a light beam transmitted by the waveguide 129.

Vertical to horizontal propagation converters are well known in the art. For example, in one embodiment, vertical to horizontal propagation converter 137 may be a grating coupler. In other embodiments, a tilted-curved mirror or positive tapered structure may be employed individually or in combination as vertical to horizontal propagation converter 137. In yet a further embodiment vertical to horizontal propagation converter 137 may be a butt waveguide coupler, e.g., an out-of-plane butt coupler. Vertical to horizontal propagation converter 137 may also have additional known components that allow it to function as a mode converter in order to adapt the light between the mode size of waveguide 129 and the single mode fiber mode diameter when fiber 113 is a single mode fiber.

In an embodiment, first curved mirror 123 and vertical to horizontal propagation converter 137 are part of a so-called “photonic bump” which added to PIC 105 in a wafer level process. These components are fabricated at the same wafer level process to guarantee high alignment accuracy. However, note that such a bump need not be manufactured at the same time that PIC 105 is manufactured. Therefore, such a photonic bump can be added by another party, i.e., a party who did not manufacture the rest of PIC 105.

In some embodiments, at least one of first curved mirror 123 and second curved mirror 125 is structured to reflect all wavelengths of light incident thereupon.

In some embodiments, spacer 121 is glued, e.g., using an adhesive, to detachable plug die 609 as described above with regard to detachable plug die 109. In some embodiments, additional spacer portion 661 is glued, e.g., using an adhesive, to PIC 605. Additional spacer portion 661 may be made of any transparent and non-conductive material, such as glass, polydimethylsiloxane, or any other index matching material. While the alignment features are shown in FIG. 6 as being on the PIC, in other embodiments they may be made on additional spacer portion 661 or a combination thereof.

In one embodiment of the invention, fine alignment features may be incorporated into additional spacer portion 661 in addition to or in lieu of those of PIC 105. In one embodiment of the invention, PIC 105 may include alignment features to help insure proper placement of additional spacer portion 661.

Due to the detachability of plug die 109 from PIC 105, there may be a gap, e.g., air gap 663, between spacer 121 and additional spacer portion 661. Such a gap may cause mismatches at the boundaries with spacer 121 and additional spacer portion 661 resulting in signal loss. To ameliorate such loss, a layer of antireflective coating may be applied to one or more portions of one or both of the surfaces of spacer 121 and additional spacer portion. More specifically, in some embodiments an antireflective coating layer is applied to at least a portion of the surface of spacer 121 that faces PIC 605. In some embodiments an antireflective coating layer is applied to at least a portion of the surface of additional spacer portion 661 that faces detachable plug die 609. Such antireflective coating may be a dielectric material may be a layer of magnesium fluoride, although those of ordinary skill in the art will be able to select an antireflective coating suitable to the materials and gap employed. Advantageously, the antireflective coating layers may substantially overcome the difference, i.e., a mismatch, in the index of refraction as light propagates from one medium to another.

The total spacing height between PIC 605 and plug die 609, and in particular the height between the mirrors, which is determined by the total height of spacer 121 which includes any antireflective coating if present, spacer portion 661 which includes any antireflective coating if present, and any gap between them, e.g., gap 663, determines, in part, the efficiency of the transference of a light beam, i.e., optical signal, that is propagating along the optical path. Specifically, the greater the total height is, the less the efficient is the transference. Those of ordinary skill in the art will readily be able to determine an appropriate height for the total spacing and each of its component elements. In an exemplary and non-limiting embodiment, the total height is set to 300-μm.

Although the optical path was described regarding a connection between a single fiber and PIC 605, it will be clear to those of ordinary skill in that the illustrative path may be applied to a plurality of fibers, e.g., all fibers 113 in fiber ribbon 113.

Also shown in FIG. 6 is MCM 101 to which PIC 605 is attached by microbumps 161. Microbumps 161 are each a ball of solder that provides contact between PIC 605 package and MCM 101. In one embodiment, one or more of microbumps 161 may consist of a downsized copper pillar and solder with height of less than 20 □m. Microbumps 161 electronically connect MCM 101 and PIC 605. Typically microbumps 161 connect copper pads on MCM 101 and PIC 605 and soldering is performed by reflow soldering.

FIG. 6 further shows the section of receptacle 107 that is visible in the view of FIG.

Detachable plug die 109 may have trenches, e.g., V-grooves, to hold each corresponding fiber 113 so as to properly space them.

FIG. 7 shows illustrative surface 771 usable for detachable plugs 109 or 609 in which each second curved mirror 125 and tilted flat mirror 127 are formed. Also, shown in FIG. 7 are trenches, 741, e.g., V-grooves for guiding optical fibers 113. FIG. 7 shows four fiber trenches 741-1 through 741-4. Each fiber trench 741 adjoins a tilted flat mirror 127. In the embodiment shown in FIG. 7 fiber trench 741 is shaped as a V-groove formed in the substrate layer of detachable plugs 109 or 609. Each of fiber trenches 741 may be formed by etching. Each of tilted flat mirrors 127-1 through 127-4 is oriented in the manner described hereinabove. FIG. 7 also shows four second curved mirrors 125-1 through 125-4. Each of second curved mirrors 125 is oriented as is second curved mirror 125 shown in FIG. 6.

It should be noted that only 2 optical fibers 113-1 and 113-2 and four fiber trenches 741 are shown in FIG. 7 for illustrative purposes only. Other numbers of optical fibers and trenches may be utilized without departing from the scope of the disclosed embodiments. It should be further noted that trenches 741 are described as V-grooves. However, any type of groove shape can be utilized, such as square, cylinder, diamond, and the like.

FIG. 7 shows optical fibers 113-1 and 113-2 are placed in the fiber trenches 741-1 and 741-2, respectively. In one embodiment, the height of at least one of fiber trenches 741 is substantially the same as the diameter of a one of optical fibers 113 that is placed therein. Doing so with all of fibers 113 enables spacer 121 to have a flat surface that can be flush against detachable plug dies 109 or 609. However, in other embodiments, spacer 121 may be shaped so as to accommodate other heights for fiber trenches 741. Tilted flat mirrors 127 and second curved mirrors 125 should be positioned to provide for a proper optical path with respect to the depth and orientation of fiber trenches 741. The depths of trenches 741 shown in FIG. 7 and the diameter of fibers 113 shown in FIG. 7 are simply for pedagogical purposes to make it easy to facilitate explanation of the concept and do not reflect any particular preferred or real-world depth, diameter, or optical path.

Processes for creating a fiber trench are well known in the art.

FIG. 8 is an exemplary diagram utilized to describe the angles and distance of coupler 100 according to an embodiment. The embodiment shown in FIG. 8 includes first curved mirror 123, located on PIC 105 along with second curved mirror 125 and tilted flat mirror 127 in detachable plug die 109. Also shown is separation 821. In this example, a drain is optical fiber 113 and an exit point of a waveguide of PIC 105, not shown but see waveguide 129 in FIG. 6, is source 861 for the light beam.

Several adjustable parameters determine the implementation of removable coupler 100, namely, height of separation 821, main propagation angles (α, β, γ), the propagation medium type of the separation 821, and a target tolerance for misalignment. Separation 821 is composed typically of at least three portions, namely spacer 121, gap 663, and additional spacer portion 661.

The light beam's radius is determined by the light beam's radius at the source 861, the medium in which the beam propagates, and the wavelength of the light beam. First, the angle of divergence (θ) is selected as the angle where the intensity of the light beam is 1% of the intensity at the center of the beam. Then, in an exemplary embodiment, the main propagation angles (α, β, γ) are set to meet the following constraints:

2α=β

β=γ

Typically, the value of θ is 8°-12°. It should be noted that other constraints may be set to different target tolerances. As noted above, the spacer height 863, represented as L in the equations below, is set based on the allowed tolerances, e.g., for rotation and leveling errors. In an exemplary embodiment, L equals 300 μm.

In an embodiment, first and second curved mirrors 123 and 125 are designed so that when detachable plug die 109 is inserted into receptacle 107 the mirror's respective centers are located where the main propagation axis intersects each respective mirror. Specifically, the mirrors are designed such that the center of second curved mirror 123 is at a distance D₁ from the source 861. In an embodiment, the distance D₁ is computed as follows:

D₁=2×L×tan(α));

The center of first curved mirror 125 is at a distance D₂ from optical fiber 113 acting as the drain. In an embodiment, the distance D₂ is computed as follows:

D₂=2×L× tan(γ)

Further, the lateral distance, to have a substantially 0 μm misalignment between first and second curved mirrors 123 and 125, is computed as follows:

L×tan (α) In an embodiment, first and second curved mirrors 123 and 125 are shaped in such a way that all light beams from the source 861 are reflected and collimated at the angle α after first curved mirror 123 and focused to optical fiber 113 acting as the drain after being reflected by second curved mirror 125. The surfaces of first and second curved mirrors 123 and 125 are large enough to cover the divergence axis. It should be noted that all calculations are performed under 0 misalignment conditions. Although the embodiments disclosed herein describe the use of curved mirrors for propagating light beams, other arrangements can be realized using other reflective or focusing elements, such as optical lenses, zone plates, e.g., Fresnel zone plates, and the like.

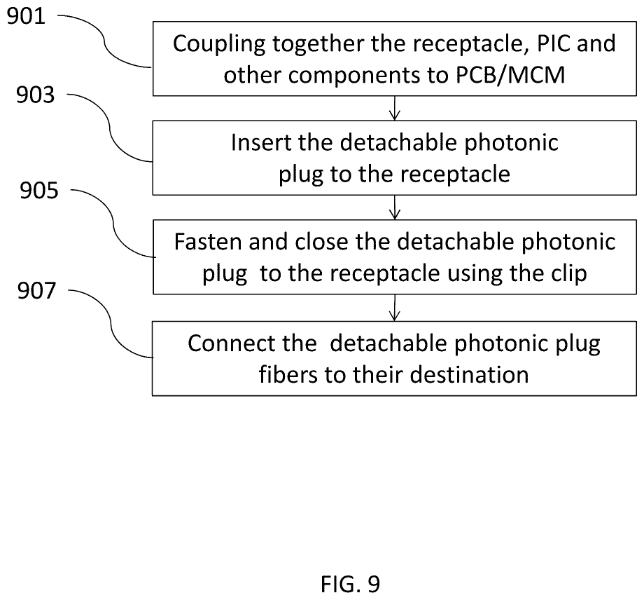

FIG. 9 shows a flowchart of an illustrative process for assembling a detachable plug and connecting an end of fibers to a PIC in accordance with an embodiment. The process is entered in step 901 in which a receptacle, e.g., receptacle 107, a PIC, e.g. PIC 105 or 605, and any other optional components not part of the detachable fiber plug, are coupled to a MCM, e.g. MCM 101, or a printed circuit board. The printed circuit board may host, or become part of, the MCM. Such coupling may be performed using soldering, adhesive, a combination thereof, and the like and may be different for various items being coupled together. For example, in one embodiment, a portion of the receptacle may be glued, e.g., using an adhesive, to PIC 105. In another embodiment a portion of the receptacle may be soldered, e.g., using reflow soldering, to MCM 101. The PIC may be soldered to the MCM, e.g., as described hereinabove in connection with FIG. 6. As part of the coupling the receptacle is permanently mounted so that at least a portion of the receptacle extends over at least a portion of the PIC, e.g., as shown in FIGS. 1-4 with regards to PIC 105 and receptacle 107.

Next, in step 903, the detachable photonic plug is inserted into the receptacle. Advantageously, this step is performed after any soldering, e.g., reflow soldering, that may be required to form all of the components coupled together in step 901 as well as to perform the coupling of step 901. Advantageously, coupling fibers, e.g., fibers 113, to a PIC, e.g., PIC 105 or 604, is performed after all soldering, e.g., used to assemble an MCM, e.g., MCM 101, is completed.

Thereafter, in step 905, a clip, e.g., clip 111, is employed to close the detachable photonic plug by fastening or securing the detachable photonic plug die, e.g., detachable photonic plug die 109 or 609, within the receptacle.

Lastly, in step 907, the opposite ends of the fibers, i.e., the fiber ends not within the receptacle, are connected to their destination.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise a set of elements comprises one or more elements. In addition, terminology of the form “at least one of A, B, or C” or “one or more of A, B, or C” or “at least one of the group consisting of A, B, and C” or “at least one of A, B, and C” used in the description or the claims means “A or B or C or any combination of these elements.” For example, this terminology may include A, or B, or C, or A and B, or A and C, or A and B and C, or 2A, or 2B, or 2C, and so on.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. An apparatus, comprising:
a receptacle configured to receive a detachable photonic plug configured to couple at least one optical fiber to a photonic integrated circuit (PIC); and
a photonic bump of the PIC, the photonic bump having at least one fine alignment feature.

2. The apparatus of claim 1, wherein the receptacle is located over at least a portion of the PIC.

3. The apparatus of claim 1, wherein the photonic bump further comprises at least one curved mirror.

4. The apparatus of claim 1, wherein the photonic bump comprises at least one vertical to horizontal propagation converter.

5. The apparatus of claim 1, further comprising a clip, removably coupled to the receptacle, to secure a detachable plug die of the detachable photonic plug within the receptacle.

6. The apparatus of claim 1, wherein the photonic bump further comprises a substantially transparent spacer located above the PIC.

7. The apparatus of claim 6, wherein a portion of a surface of the substantially transparent spacer is coated with an antireflective coating.

8. The apparatus of claim 1, wherein the at least one fine alignment feature of the photonic bump is configured to mate with at least one fine alignment feature of a detachable plug die of the detachable photonic plug when the detachable plug die is inserted into the receptacle.

9. The apparatus of claim 1, wherein the photonic bump and the photonic plug are configured to enable relaxed optical alignment tolerances in three dimensions between the optical fiber and the PIC via a first curved mirror of the photonic bump and a second curved mirror of the detachable photonic plug.

10. An apparatus, comprising:
a receptacle configured to connect to a photonic integrated circuit (PIC) substrate and to receive a detachable photonic plug configured to optically couple an optical fiber to the PIC via a photonic bump,
wherein the receptacle is configured to first align the detachable photonic plug with respect to the PIC.

11. The apparatus of claim 10, wherein the first aligning of the detachable photonic plug with respect to the PIC comprises a rough alignment and enables fine alignment between the detachable photonic plug and the PIC via first fine alignment features of the detachable photonic plug and corresponding second fine alignment features of the PIC.

12. The apparatus of claim 10, wherein the photonic bump comprises a substantially flat tilted mirror and a curved mirror.

13. The apparatus of claim 10, wherein the photonic bump is configured to enable relaxed alignment tolerances in three dimensions between the optical fiber and the PIC.

14. The apparatus of claim 10, wherein the receptacle is further configured to receive a substantially transparent spacer between the detachable photonic plug and the PIC.

15. An apparatus, comprising:
a detachable photonic plug receptacle configured to:
connect to a photonic integrated circuit (PIC) substrate; and
receive a detachable photonic plug configured to optically couple an optical fiber to the PIC via a photonic bump,
wherein the photonic bump is configured to enable relaxed tolerances in three dimensions between the optical fiber and the PIC via a curved mirror.

16. The apparatus of claim 15, wherein the receptacle is further configured to rough position the detachable photonic plug in relation to the photonic bump.

17. The apparatus of claim 15, further comprising a clip coupled to the receptacle configured to secure the detachable photonic plug within the receptacle.

18. The apparatus of claim 15, wherein the receptacle is further configured to receive a substantially transparent spacer between the detachable photonic plug and the PIC.

19. The apparatus of claim 15, wherein the relaxed tolerances in the three dimensions between the optical fiber and the PIC are further enabled via a second curved mirror of the detachable photonic plug.

20. The apparatus of claim 15, wherein the photonic bump is further configured to enable the relaxed tolerances in the three dimensions between the optical fiber and the PIC via a tilted substantially flat mirror.
